(19) United States
(12) Patent Application Publication
(10) Pub. No.: US 2015/0081420 A1
(43) Pub. Date: Mar. 19, 2015

(54) METHODS AND SYSTEMS FOR IDENTIFYING RELATIONSHIPS BETWEEN ONLINE CONTENT ITEMS

(71) Applicant: GOOGLE INC., Mountain View, CA (US)

(72) Inventors: Jianyuan Min, Mountain View, CA (US); Wenjun Lu, Cupertino, CA (US); Stephen Leung, Cupertino, CA (US); Xuefu Wang, Los Altos, CA (US); Li Zou, Fremont, CA (US)

(73) Assignee: GOOGLE INC., Mountain View, CA (US)

(21) Appl. No.: 14/030,431

(22) Filed: Sep. 18, 2013

(51) Int. Cl. G06Q 30/02; G06F 17/30

(52) U.S. Cl. CPC G06Q 30/0244; G06F 17/30864
USPC 705/14.43

(57) ABSTRACT

A computer-implemented method for identifying relationships between online content items uses a computing device including a processor and a memory. The method includes identifying a first content item and identifying a plurality of occurrence results for the first content item. Each occurrence result of the plurality of occurrence results includes an indicator that the first content item was retrieved along with a list of other content items based on an online activity of at least one user device. The method also includes computing a number of co-occurrence events involving the first content item and a second content item from the plurality of occurrence results. Each co-occurrence event includes an indicator that both first content item and second content item were retrieved together in an occurrence result. The method further includes computing a relationship value between first content item and second content item using at least the number of co-occurrence events.

### BACKGROUND

This specification relates to presenting online content to users accessing the Internet and, more particularly, to methods and systems for identifying relationships between different online content items wherein these relationships are used for delivering more relevant content items to online users.

A content item, such as an advertisement, may be displayed on a user computing device in a webpage or other publication. The content item may be presented within the publication because the content item is pertinent to the publication or it may otherwise be of interest to a user viewing the publication. Some content items may be selected for display on a particular web page based on information associated with the user computing device, or based on keywords found in the web page, or based on search terms provided to a search engine. In some cases, advertisers are able to customize when and how their particular ads appear on a web page or a search results page. As such, some configurations may lead to greater impact for the advertiser (i.e., a well-performing ad), and some configurations may have a lesser impact (i.e., a poor-performing ad).

### BRIEF DESCRIPTION OF THE DISCLOSURE

In one aspect, a computer-implemented method for identifying relationships between online content items is provided. The method uses a computing device including a processor and a memory. The method includes identifying a first content item. The method also includes identifying a plurality of occurrence results for the first content item. Each occurrence result of the plurality of occurrence results includes an indicator that the first content item was retrieved along with a list of other content items based, at least in part, on an online activity of at least one user device. The method further includes computing a number of co-occurrence events involving the first content item and a second content item from the plurality of occurrence results. Each co-occurrence event includes an indicator that both the first content item and the second content item were retrieved together in an occurrence result. The method also includes computing a relationship value between the first content item and the second content item using at least the number of co-occurrence events.

In another aspect, a computer system is provided. The computer system includes at least one processor. The computer system also includes at least one memory comprising computer-executable instructions that, when executed by said at least one processor, cause said at least one processor to identify a first content item stored within the at least one memory. The computer-executable instructions also cause the processor to identify a plurality of occurrence results for the first content item. Each occurrence result of the plurality of occurrence results includes an indicator that the first content item was retrieved along with a list of other content items based, at least in part, on an online activity of at least one user device. The computer-executable instructions further cause the processor to compute a number of co-occurrence events involving the first content item and a second content item from the plurality of occurrence results. Each co-occurrence event includes an indicator that both the first content item and the second content item were retrieved together in an occurrence result. The computer-executable instructions also cause the processor to compute a relationship value between the first content item and the second content item using at least the number of co-occurrence events.

In yet another aspect, computer-readable storage media having computer-executable instructions embodied thereon are provided. When executed by at least one processor, the computer-executable instructions cause the processor to identify a first content item stored within a memory. The computer-executable instructions also cause the processor to identify a plurality of occurrence results for the first content item. Each occurrence result of the plurality of occurrence results includes an indicator that the first content item was retrieved along with a list of other content items based, at least in part, on an online activity of at least one user device. The computer-executable instructions further cause the processor to compute a number of co-occurrence events involving the first content item and a second content item from the plurality of occurrence results. Each co-occurrence event includes an indicator that both the first content item and the second content item were retrieved together in an occurrence result. The computer-executable instructions also cause the processor to compute a relationship value between the first content item and the second content item using at least the number of co-occurrence events.

### BRIEF DESCRIPTION OF THE DRAWINGS

FIGS. 1-7 show exemplary embodiments of the methods and systems described herein.

FIG. 1 is a diagram depicting an example networked environment for identifying relationships between online content.

FIG. 2 is a block diagram of a computing device used for identifying relationships between online content items as shown in the advertising environment of FIG. 1.

FIG. 3 is an illustration of an example search results page as seen by an online user of the Internet using a computing device of FIG. 2 in the advertising environment shown in FIG. 1.

FIG. 4 is an illustration of a portion of an example ads co-occur graph that may be generated in accordance with the systems and processes described herein.

FIG. 5 is an illustration of a portion of another example ads co-occur graph that may be generated in accordance with the systems and processes described herein.

FIG. 6 is an example method for identifying relationships between different online content items, such as online advertisements, using the computing device of FIG. 2 in the advertising environment shown in FIG. 1.

FIG. 7 is a diagram of components of one or more example computing devices that may be used in the environment shown in FIG. 1.

Like reference numbers and designations in the various drawings indicate like elements.

### DETAILED DESCRIPTION OF THE DISCLOSURE

Embodiments of the methods and systems described herein enable a content management system (“CMS”) to identify relevant content items for an online user by identifying relationships between different online content items. More specifically, the methods and systems described herein facilitate identifying relationships between content items, such as online advertisements (“ads”), by examining co-occurrences of the content items within a body of occurrence data, such as a body of search results.

In the example embodiment, online content items (e.g., ads) are said to “occur” when the content item is offered or delivered for display on a user device. These occurrences of online content items are also referred to herein as “occurrence results.” Two separate online content items are said to “co-occur” when the two ads appear together within the results of the same search query. These co-occurrences of online content items are also referred to herein as “co-occurrence events.” For example, if an online user enters a search query on a search engine, the search query generates a list of resulting web pages (i.e., organic listings) presented to the user on a search results page. The results page may also include one or more ads or “ad impressions” (i.e., paid listings, also referred to as an ad occurrence). When two ads, such as AD1 and AD2, appear within the same set of search results, the two ads are said to co-occur. Ad co-occurrence may be viewed as an indication of some aspect of relation between the two ads AD1 and AD2. For example, the more times AD1 and AD2 co-occur, the stronger the relationship between the two ads appears to be. Thus, realization of this relationship may offer analysts opportunities to leverage the similarities by, for example, using data from AD2 to improve the performance of AD1.

Further, in the example embodiment, a graph is built that represents co-occurrence relationships between ads. Generally, a graph (in the mathematical field of graph theory) includes “nodes” (or “vertices”) and links or “edges” that connect two nodes. In the example embodiment, a graph is constructed within a computing device, such as the CMS, by examining the search logs of many users and identifying ad co-occurrences. Within the graph, each node represents a single ad (e.g., AD1 would be represented by a first node, and AD2 would be represented by a second node), and each edge represents the relationship between the two nodes (e.g., AD1 and AD2) that the edge connects. Each edge has a value associated with it that represents a strength of the relationship between the two ads. In some embodiments, when ads co-occur more often together, the strength of their relationship (i.e., the value of their corresponding shared edge) increases.

As such, the ads co-occur graph is constructed and leveraged for analyzing relationships between ads. These relationships may be leveraged for analytical purposes by advertisers, content management services, and other involved parties. For example, an analyst may identify an under-performing ad such as “AD1” based on some performance metric for that ad (e.g., an ad that is not being selected and has a low impression count, or an ad that has a sufficient number of impressions but the impressions are not generating enough conversions or sales). AD1 may be underperforming because of its advertisement settings such as, for example, poor keyword selection. The analyst looks at the ads co-occur graph and, more specifically, at any other ads with which AD1 has a strong relationship. If the analyst finds a “strong neighbor” of AD1 (i.e., another node with which the underperforming ad shares a high-valued edge due to high co-occurrence), such as AD2, and if that neighbor is performing better than AD1 (e.g., has higher performance metrics than AD1), the analyst may look to the advertisement settings of the neighbor ad (AD2) for ideas of how the underperforming ad (AD1) may be reconfigured. For example, if AD2 has high click-through rates and uses certain keywords not used by AD1, the analyst may consider adding those same keywords to AD1. As such, the underperforming ad (AD1) may start to perform better with the new keywords. Since the keywords were used by a neighbor that frequently co-occurs with the underperforming ad, that co-occurrence relationship may help improve performance of the underperforming ad.

In some embodiments, the ads co-occur graph may also be used to analyze advertisement budgets. For example, in some embodiments, an advertisement may be assigned a fixed budget (i.e., another example advertisement setting in which a fixed amount of money is configured and used dynamically to pay for purchasing online content from the search engine owner). Every time a user clicks on an ad, the search engine owner will charge the advertiser (i.e., decrement an amount from the budget). The ads co-occur graph may be used to identify an advertisement with low occurrences due to having consumed its budget (i.e., a budget-constrained ad). The strong neighbors of the budget-constrained ad may be examined, and a new budget may be suggested for the budget-constrained ad, such as an average of the neighbors' budgets.

The ads co-occur graph may also be used to analyze bidding suggestions. In some embodiments, the bid is the amount the advertiser is willing to pay to the search engine owner when a user clicks on the ad. A ranking (i.e., display order) of ads may be determined not only by the relevance to the search query, but also by the bid amount. In other words, a higher bid amount leads to a higher ranking, and thus the more likely an ad is to show up on the front pages and top advertisement slots within search query results. The ads co-occur graph may be used to identify a low performance ad and compare its bid amount to better-performing strong neighbors. A higher bid amount may be recommended in order to improve performance.

Further, the ads co-occur graph may be used to reveal other relevant ads suggestions for individual users during their online activities. When a particular user clicks on an ad on a search results page, this indicates that the user is interested in the product and/or theme of that ad type. The search engine may use the ads co-occur graph to identify strong neighbors (i.e., similar ads) and present these ads to the user during subsequent activities.

The methods and systems described herein may be implemented using computer programming or engineering techniques including computer software, firmware, hardware, or any combination or subset thereof, wherein the technical effects may be achieved by performing at least one of the following steps: (a) identifying a first content item, such as an ad, in a memory; (b) identifying a plurality of occurrence results involving a first content item wherein each occurrence result includes providing the first content item for display on a user device; (c) computing a number of co-occurrence events involving the first content item and a second content item from the plurality of occurrence results, wherein each co-occurrence event includes providing both the first content item and the second content item for display on a user device; (d) computing a relationship value between the first content item and the second content item using at least the number of co-occurrence events; (e) identifying a first advertisement setting for the first content item, wherein the first advertisement setting relates to the plurality of occurrence results for the first content item; (f) providing a recommendation for adjusting the first advertisement setting based at least in part on the relationship value between the first content item and the second content item; (g) identifying a second advertisement setting for the second content item, wherein providing a recommendation further comprises providing a recommendation based at least in part on the second advertisement setting; (h) identifying a first performance metric associated with the first content item and a second performance metric associated with the second content item, wherein providing a recommendation further comprising providing a recommendation based at least in part on a comparison between the first performance metric and the second performance metric; (i) identifying a plurality of occurrence results from a plurality of search results; (j) building a graph data structure in the memory; (k) providing a visual representation of the graph data structure to a user of the computing device; (l) computing a total number of occurrences of the first content item; (m) computing the relationship value by dividing the number of co-occurrence events by the total number of occurrences of the first content item; (n) identifying a plurality of occurrence results from a plurality of search results occurring during a first time period; and (o) outputting the relationship value to a user of the computing device.

The following detailed description illustrates embodiments of the disclosure by way of example and not by way of limitation. It is contemplated that the disclosure has general application to processing web traffic regardless of the type of webserver, how the traffic reaches the webserver, and/or the type of content provided by the webserver.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

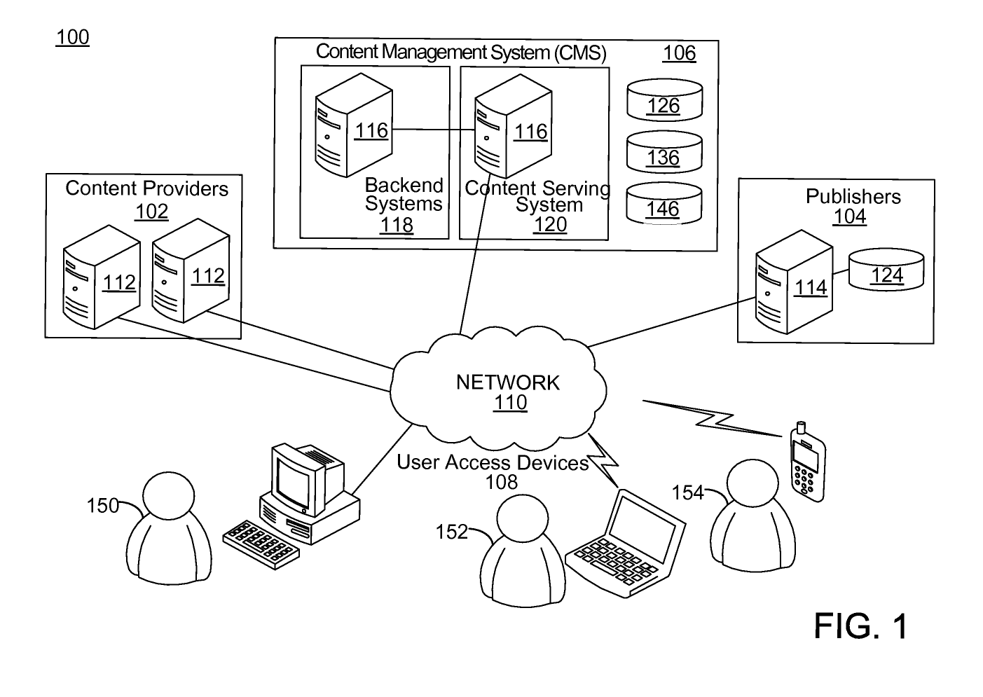

FIG. 1 is a diagram depicting an example networked environment. With reference to FIG. 1, an example networked environment 100 may include one or more content providers 102, one or more publishers 104, a content management system (CMS) 106, and one or more user access devices 108 (“client computing devices”), which may be coupled to a network 110. User access devices are used by users 150, 152, and 154. Each of the elements 102, 104, 106, 108 and 110 in FIG. 1 may be implemented or associated with hardware components, software components, or firmware components or any combination of such components. The elements 102, 104, 106, 108 and 110 can, for example, be implemented or associated with general purpose servers, software processes and engines, and/or various embedded systems. The elements 102, 104, 106 and 110 may serve, for example, as a content distribution network. In the example embodiment, content providers 102 include advertisers, and CMS 106 is an advertising management system.

The content providers 102 may include any entities that are associated with content (i.e., a content item or multiple content items). In some embodiments, the content includes any form of communication in which one or more products, services, ideas, messages, people, organizations or other items are identified and promoted (or otherwise communicated). Content is not limited to advertisements and commercial promotions. Rather, content may include public service announcements or any other types of notices, such as public notices published in printed or electronic press or broadcasts.

Content may be communicated via various mediums and in various forms. In some examples, content may be communicated through an interactive medium, such as the Internet, and may include graphical content (e.g., banner content), textual content, image content, audio content, video content, content combining one of more of any of such components, or any form of electronically delivered content. Content may include embedded information, such as embedded media, links, meta-information, and/or machine executable instructions. Content could also be communicated through RSS (Really Simple Syndication) feeds, radio channels, television channels, print media, and other media.

Content can refer to both a single “creative” and a “content group.” A creative refers to any entity that represents one content impression, also referred to herein as an advertisement, or “ad”. A content impression refers to any form of presentation of content such that it is viewable/receivable by a user. In some examples, a content impression may occur when content is displayed on a display device of a user access device (i.e., a “client computing device”). A content group refers, for example, to an entity that represents a group of creatives that share a common characteristic, such as having the same content selection and recommendation criteria. Content groups can be used to create a content campaign.

In some embodiments, one or more ads are affiliated with an “ad group.” An ad group includes one or more ads along with other associated information related to those ads, such as, for example and without limitation, a title, a headline, a budget, targeting criteria, and keywords. In the example embodiment, an ad group includes one ad and associated information. As used herein, the term “ad” and “ad group” may be used interchangeably, as some operations that are performed relative to an as may also be performed relative to an ad group, and vice versa.

The content providers 102 may provide (or be otherwise associated with) products and/or services related to content. The content providers 102 may include or be associated with, for example, retailers, wholesalers, warehouses, manufacturers, distributors, health care providers, educational establishments, financial establishments, technology providers, energy providers, utility providers, or any other product or service providers or distributors.

The content providers 102 may directly or indirectly generate, maintain, and/or analyze content, which may be related to products or services offered by or otherwise associated with the content providers 102. The content providers 102 may include or maintain one or more data processing systems 112, such as servers or embedded systems, coupled to the network 110. The content providers 102 may include or maintain one or more processes that run on one or more data processing systems.

The publishers 104 may include any entities that generate, maintain, provide, present and/or otherwise process publications in the environment 100. “Publishers,” in particular, include authors of publications, wherein authors may be individual persons, or, in the case of works made for hire, the proprietor(s) who hired the individual(s) responsible for creating the online publications. The term “publication” refers to various types of web-based, software application-based and/or otherwise presented information, including articles, discussion threads, reports, analyses, financial statements, music, video, graphics, search results, web page listings, information feeds (e.g., RSS feeds), television broadcasts, radio broadcasts, printed information, or any other form of information that may be presented to a user using a computing device such as one of user access devices 108.

In some implementations, the publishers 104 may include publishers with an Internet presence, such as online publication and news providers (e.g., online newspapers, online magazines, television websites, etc.), online service providers (e.g., financial service providers, health service providers, etc.), and the like. The publishers 104 can include software application providers, television broadcasters, radio broadcasters, satellite broadcasters, and other providers of publications. One or more of the publishers 104 may represent a publication network that is associated with the CMS 106.

The publishers 104 may receive requests from the user access devices 108 (or other elements in the environment 100) and provide or present publications to the requesting devices. The publishers may provide or present publications via various mediums and in various forms, including web based and non-web based mediums and forms. The publishers 104 may generate and/or maintain such publications and/or retrieve the publications from other network resources.

In addition to publications, the publishers 104 may be configured to integrate or combine retrieved publications with content that is related or relevant to the retrieved publication for display to users 150, 152, and 154. The relevant content may be provided from the CMS 106 and may be combined with a publication for display to users 150, 152, and 154. In some examples, the publishers 104 may retrieve a publication for display on a particular user access device 108 and then forward the publication to the user access device 108 along with code that causes content from the CMS 106 to be displayed to the user 150, 152, or 154. In other examples, the publishers 104 may retrieve a publication, retrieve relevant content (e.g., from the CMS 106 or the content providers 102), and then integrate the content and the publication to form a page for display to the user 150, 152, or 154.

As noted above, one or more of the publishers 104 may represent a publication network. In such an implementation, the content providers 102 may be able to present content to users through this publication network.

The publishers 104 may include or maintain one or more data processing systems 114, such as servers or embedded systems, coupled to the network 110. They may include or maintain one or more processes that run on data processing systems. In some examples, the publishers 104 may include one or more publication repositories 124 for storing publications and other information.

The CMS 106 manages content and provides various services to the content providers 102, the publishers 104, and the user access devices 108. The CMS 106 may store content in a content repository 126 and facilitate the distribution or selective provision and recommendation of content through the environment 100 to the user access devices 108.

The CMS 106 may include one or more data processing systems 116, such as servers or embedded systems, coupled to the network 110. It can also include one or more processes, such as server processes. In some examples, the CMS 106 may include a content serving system 120 and one or more backend processing systems 118. The content serving system 120 may include one or more data processing systems 116 and may perform functionality associated with delivering content to publishers or user access devices 108. The backend processing systems 118 may include one or more data processing systems 116 and may perform functionality associated with identifying relevant content to deliver, processing various rules, performing filtering processes, generating reports, maintaining accounts and usage information, and other backend system processing. The CMS 106 can use the backend processing systems 118 and the content serving system 120 to selectively recommend and provide relevant content from the content providers 102 through the publishers 104 to the user access devices 108.

The CMS 106 may include or access one or more crawling, indexing and searching modules (not shown). These modules may browse accessible resources (e.g., the World Wide Web, publisher content, data feeds, etc.) to identify, index and store information. The modules may browse information and create copies of the browsed information for subsequent processing. The modules may also check links, validate code, harvest information, and/or perform other maintenance or other tasks.

Searching modules may search information from various resources, such as the World Wide Web, publications, intranets, newsgroups, databases, and/or directories. The search modules may employ one or more known search or other processes to search data. In some implementations, the search modules may index crawled content and/or content received from data feeds to build one or more search indices. The search indices may be used to facilitate rapid retrieval of information relevant to a search query. Searching modules may also store search results including one or more of search query terms, search results elements, and ads impressions served.

The CMS 106 may include one or more interface or frontend modules for providing the various features to content providers, publishers, and user access devices. For example, the CMS 106 may provide one or more publisher front-end interfaces (PFEs) for allowing publishers to interact with the CMS 106. The CMS 106 may also provide one or more content provider front-end interfaces (CPFEs) for allowing content providers to interact with the CMS 106. In some examples, the front-end interfaces may be configured as web applications that provide users with network access to features available in the CMS 106.

The CMS 106 provides various content management features to the content providers 102. The CMS 106 features may allow users to set up user accounts, set account preferences, create content, configure advertisement settings such as keywords for content, create campaigns or initiatives for multiple products or businesses, view reports associated with accounts, analyze costs and return on investment, selectively identify customers in different regions, selectively recommend and provide content to particular publishers, analyze financial information, analyze content performance, estimate content traffic, access keyword tools, add graphics and animations to content, etc.

The CMS 106 may allow the content providers 102 to create content and configure advertisement settings such as keywords for which the content will appear. In some examples, the CMS 106 may provide content to user access devices or publishers when keywords associated with that content are included in a user request or a requested publication. The CMS 106 may also allow the content providers 102 to set bids for content. A bid may represent the maximum amount a content provider is willing to pay for each content impression, user click-through of content or other interaction with content. A click-through can include any action a user takes to select content. The content providers 102 may also choose a currency and monthly budget.

The CMS 106 may also allow the content providers 102 to view information about content impressions, which may be maintained by the CMS 106. The CMS 106 may be configured to determine and maintain the number of content impressions relative to a particular website or keyword. The CMS 106 may also determine and maintain the number of click-through's for content as well as the ratio of click-trough's to impressions.

The CMS 106 may also allow the content providers 102 to select and/or create conversion types for content. A “conversion” may occur when a user consummates a transaction related to given content. A conversion could be defined to occur when a user clicks on content, for example a specific content item, is referred to the content provider's web page, and consummates a purchase there before leaving that web page. In another example, a conversion could be defined as the display of content to a user and a corresponding purchase on the content provider's web page within a predetermined time (e.g., seven days). The CMS 106 may store conversion data and other information in a conversion data repository 136.

The CMS 106 may allow the content providers 102 to input description information associated with content. This information could be used to assist the publishers 104 in determining content to publish. The content providers 102 may additionally input a cost/value associated with selected conversion types, such as a five dollar credit to the publishers 104 for each product or service purchased.

The CMS 106 may provide various features to the publishers 104. The CMS 106 may deliver content (associated with the content providers 102) to the user access devices 108 when users access publications from the publishers 104. The CMS 106 can be configured to deliver content that is relevant to publisher sites, publications, and publisher audiences.

In some examples, the CMS 106 may crawl publications provided by the publishers 104 and deliver content that is relevant to publisher sites, publications and publisher audiences based on the crawled publications. The CMS 106 may also selectively recommend and/or provide content based on user information and behavior, such as particular search queries performed on a search engine website. The CMS 106 may store such information in a general database 146. In some examples, the CMS 106 can add search to a publisher site and deliver content configured to provide appropriate and relevant content relative to search results generated by requests from visitors of the publisher site. A combination of these and other approaches can be used to deliver relevant content.

The CMS 106 may allow the publishers 104 to search and select specific products and services as well as associated content to be displayed with publications provided by the publishers 104. For example, the publishers 104 may search through content in the content repository 126 and select certain content for display with their publications.

The CMS 106 may be configured to selectively recommend and provide content created by the content providers 102 to the user access devices 108 directly or through the publishers 104. The CMS 106 may selectively recommend and provide content to a particular publisher 104 (as described in further detail herein) or a requesting user access device 108 when a user requests search results or loads a publication from the publisher 104.

In some implementations, the CMS 106 may manage and process financial transactions among and between elements in the environment 100. For example, the CMS 106 may credit accounts associated with the publishers 104 and debit accounts of the content providers 102. These and other transactions may be based on conversion data, impressions information and/or click-through rates received and maintained by the CMS 106.

“Computing devices”, for example user access devices 108, may include any devices capable of receiving information from the network 110. The user access devices 108 could include general computing components and/or embedded systems optimized with specific components for performing specific tasks. Examples of user access devices include personal computers (e.g., desktop computers), mobile computing devices, cell phones, smart phones, head-mounted computing devices, media players/recorders, music players, game consoles, media centers, media players, electronic tablets, personal digital assistants (PDAs), television systems, audio systems, radio systems, removable storage devices, navigation systems, set top boxes, other electronic devices and the like. The user access devices 108 can also include various other elements, such as processes running on various machines.

The network 110 may include any element or system that facilitates communications among and between various network nodes, such as elements 108, 112, 114 and 116. The network 110 may include one or more telecommunications networks, such as computer networks, telephone or other communications networks, the Internet, etc. The network 110 may include a shared, public, or private data network encompassing a wide area (e.g., WAN) or local area (e.g., LAN). In some implementations, the network 110 may facilitate data exchange by way of packet switching using the Internet Protocol (IP). The network 110 may facilitate wired and/or wireless connectivity and communication.

For purposes of explanation only, certain aspects of this disclosure are described with reference to the discrete elements illustrated in FIG. 1. The number, identity and arrangement of elements in the environment 100 are not limited to what is shown. For example, the environment 100 can include any number of geographically-dispersed content providers 102, publishers 104 and/or user access devices 108, which may be discrete, integrated modules or distributed systems. Similarly, the environment 100 is not limited to a single CMS 106 and may include any number of integrated or distributed CMS systems or elements.

Furthermore, additional and/or different elements not shown may be contained in or coupled to the elements shown in FIG. 1, and/or certain illustrated elements may be absent. In some examples, the functions provided by the illustrated elements could be performed by less than the illustrated number of components or even by a single element. The illustrated elements could be implemented as individual processes running on separate machines or a single process running on a single machine.

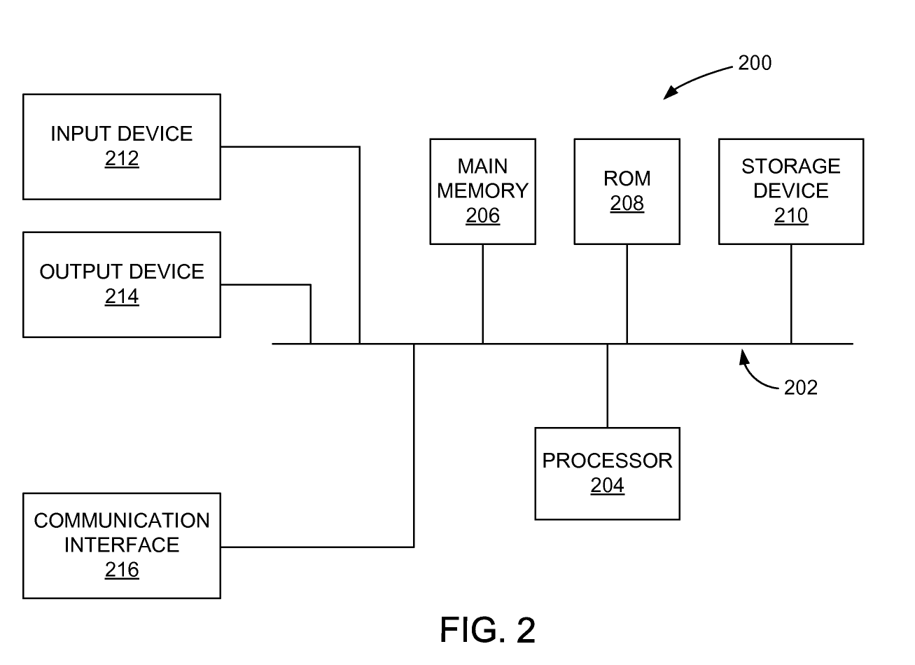

FIG. 2 is a block diagram of a computing device 200 used for identifying relationships between online content items, such as the various computing devices in advertising environment 100 (shown in FIG. 1). FIG. 2 shows an example of a generic computing device 200 intended to represent various forms of digital computers, such as laptops, desktops, workstations, personal digital assistants, servers, blade servers, mainframes, and other appropriate computers. Computing device 200 is also intended to represent various forms of mobile devices, such as personal digital assistants, cellular telephones, smart phones, and other similar computing devices. The components shown here, their connections and relationships, and their functions, are meant to be examples only, and are not meant to limit implementations of the subject matter described and/or claimed in this document.

In the example embodiment, computing device 200 could be user access device 108 or any of data processing devices 112, 114, or 116 (shown in FIG. 1). Computing device 200 may include a bus 202, a processor 204, a main memory 206, a read only memory (ROM) 208, a storage device 210, an input device 212, an output device 214, and a communication interface 216. Bus 202 may include a path that permits communication among the components of computing device 200.

Processor 204 may include any type of conventional processor, microprocessor, or processing logic that interprets and executes instructions. Processor 204 can process instructions for execution within the computing device 200, including instructions stored in the memory 206 or on the storage device 210 to display graphical information for a GUI on an external input/output device, such as display 214 coupled to a high speed interface. In other implementations, multiple processors and/or multiple buses may be used, as appropriate, along with multiple memories and types of memory. Also, multiple computing devices 200 may be connected, with each device providing portions of the necessary operations (e.g., as a server bank, a group of blade servers, or a multi-processor system).

Main memory 206 may include a random access memory (RAM) or another type of dynamic storage device that stores information and instructions for execution by processor 204. ROM 208 may include a conventional ROM device or another type of static storage device that stores static information and instructions for use by processor 204. Main memory 206 stores information within the computing device 200. In one implementation, main memory 206 is a volatile memory unit or units. In another implementation, main memory 206 is a non-volatile memory unit or units. Main memory 206 may also be another form of computer-readable medium, such as a magnetic or optical disk.

Storage device 210 may include a magnetic and/or optical recording medium and its corresponding drive. The storage device 210 is capable of providing mass storage for the computing device 200. In one implementation, the storage device 210 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as main memory 206, ROM 208, the storage device 210, or memory on processor 204.

The high speed controller manages bandwidth-intensive operations for the computing device 200, while the low speed controller manages lower bandwidth-intensive operations. Such allocation of functions is for purposes of example only. In one implementation, the high-speed controller is coupled to main memory 206, display 214 (e.g., through a graphics processor or accelerator), and to high-speed expansion ports, which may accept various expansion cards (not shown). In the implementation, low-speed controller is coupled to storage device 210 and low-speed expansion port. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

Input device 212 may include a conventional mechanism that permits computing device 200 to receive commands, instructions, or other inputs from a user 150, 152, or 154, including visual, audio, touch, button presses, stylus taps, etc. Additionally, input device may receive location information. Accordingly, input device 212 may include, for example, a camera, a microphone, one or more buttons, a touch screen, and/or a GPS receiver. Output device 214 may include a conventional mechanism that outputs information to the user, including a display (including a touch screen) and/or a speaker. Communication interface 216 may include any transceiver-like mechanism that enables computing device 200 to communicate with other devices and/or systems. For example, communication interface 216 may include mechanisms for communicating with another device or system via a network, such as network 110 (shown in FIG. 1).

As described herein, computing device 200 facilitates the presentation of content from one or more publishers, along with one or more sets of sponsored content, for example ads, to a user. Computing device 200 may perform these and other operations in response to processor 204 executing software instructions contained in a computer-readable medium, such as memory 206. A computer-readable medium may be defined as a physical or logical memory device and/or carrier wave. The software instructions may be read into memory 206 from another computer-readable medium, such as data storage device 210, or from another device via communication interface 216. The software instructions contained in memory 206 may cause processor 204 to perform processes described herein. Alternatively, hardwired circuitry may be used in place of or in combination with software instructions to implement processes consistent with the subject matter herein. Thus, implementations consistent with the principles of the subject matter disclosed herein are not limited to any specific combination of hardware circuitry and software.

The computing device 200 may be implemented in a number of different forms, as shown in the figure. For example, it may be implemented as a standard server, or multiple times in a group of such servers. It may also be implemented as part of a rack server system. In addition, it may be implemented in a personal computer such as a laptop computer. Each of such devices may contain one or more of computing device 200, and an entire system may be made up of multiple computing devices 200 communicating with each other.

The processor 204 can execute instructions within the computing device 200, including instructions stored in the main memory 206. The processor may be implemented as chips that include separate and multiple analog and digital processors. The processor may provide, for example, for coordination of the other components of the device 200, such as control of user interfaces, applications run by device 200, and wireless communication by device 200.

Computing device 200 includes a processor 204, main memory 206, ROM 208, an input device 212, an output device such as a display 214, a communication interface 216, among other components including, for example, a receiver and a transceiver. The device 200 may also be provided with a storage device 210, such as a micro-drive or other device, to provide additional storage. Each of the components are interconnected using various buses, and several of the components may be mounted on a common motherboard or in other manners as appropriate.

Computing device 200 may communicate wirelessly through communication interface 216, which may include digital signal processing circuitry where necessary. Communication interface 216 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver. In addition, short-range communication may occur, such as using a Bluetooth, WiFi, or other such transceiver (not shown). In addition, a GPS (Global Positioning system) receiver module may provide additional navigation- and location-related wireless data to device 200, which may be used as appropriate by applications running on device 200.

Computing device 200 may also communicate audibly using an audio codec, which may receive spoken information from a user and convert it to usable digital information. The audio codec may likewise generate audible sound for a user, such as through a speaker, e.g., in a handset of device. Such sound may include sound from voice telephone calls, may include recorded sound (e.g., voice messages, music files, etc.) and may also include sound generated by applications operating on computing device 200.

Computing device 200 may be implemented in a number of different forms. For example, it may be implemented as a cellular telephone, or as part of a smart phone, personal digital assistant, a computer tablet, or other similar mobile device.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system (e.g., computing device 200) that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In the example embodiment, computing device 200 is configured to receive and/or retrieve electronic documents from various other computing devices connected to computing device 200 through a communication network, and store these electronic documents within at least one of memory 206, storage device 210, and ROM 208. Computing device 200 is further configured to manage and organize these electronic documents within at least one of memory 206, storage device 210, and ROM 208 using the techniques described herein.

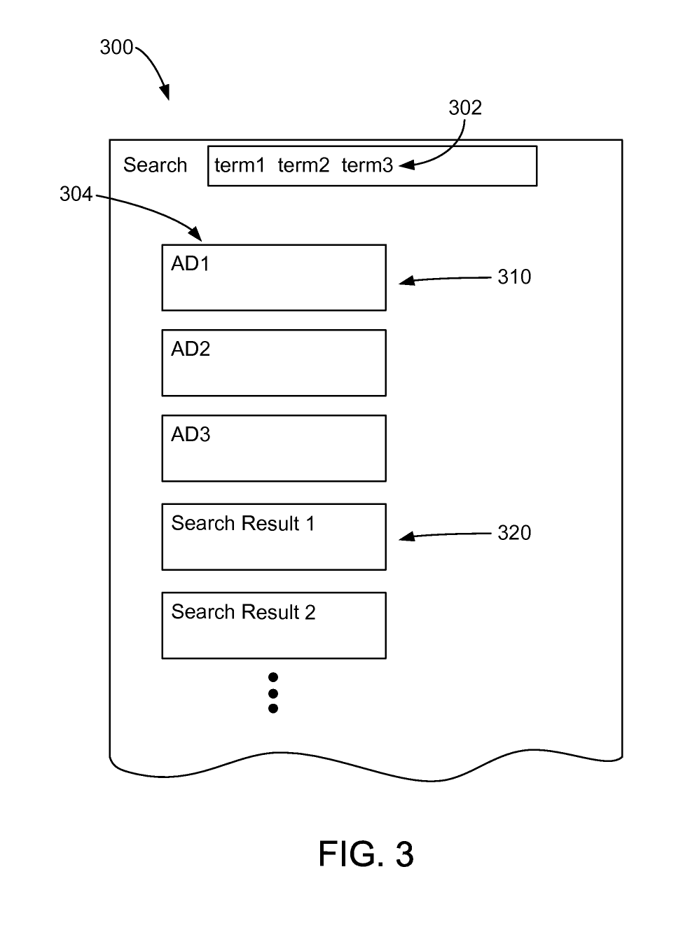

FIG. 3 is an illustration of an example search results page as seen by an online user of the Internet using a computing device of FIG. 2 in the advertising environment shown in FIG. 1. In the example embodiment, an online user such as user 150 (shown in FIG. 1) submits search terms 302 to a search engine. The search engine returns search query results 304, which may include one or more ads (i.e., online content items, also sometimes referred to as “paid listings”) 310, such as AD1, AD2, and AD3, as well as one or more search results references 320 (also sometimes referred to as “organic listings”). In the example embodiment, the search engine is similar to CMS 106 (shown in FIG. 1). It should be understood, however, that while the example embodiments are described in relation to a search engine and associated search results (i.e., a specific type of “occurrence results”), the systems and methods described herein may be practiced by any entity that has access to occurrence data and/or co-occurrence data for a plurality of advertisements such as, for example, advertisement display logs for web pages, or other content items.

In the example shown in FIG. 3, AD1, AD2, and AD3 co-occur because they appear together within the results of a single search query (i.e., an indicator both that each of these ads occur within an occurrence result, and an indicator that they all co-occur with each other in an occurrence result). In some embodiments, search query results 304 are stored in a search query log within a database such as database 126 (shown in FIG. 1), and includes at least the search terms 302 and the associated ads 310 that appeared. During operation, in the example embodiment, many search query results such as search query result 304 are stored in a database for later use. As described in greater detail below, the database of search query results is used to analyze co-occurrences (co-occurrence events) between various ads.

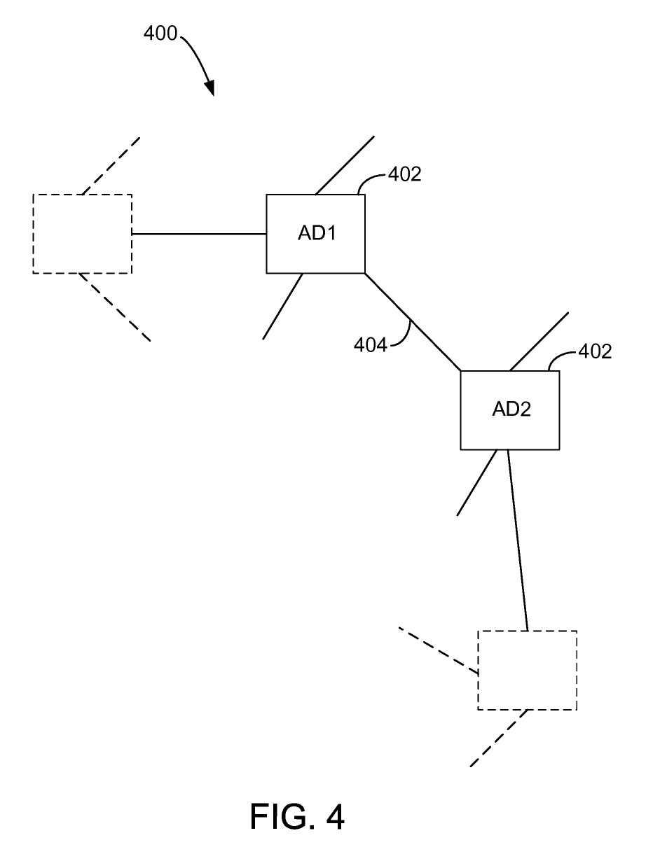

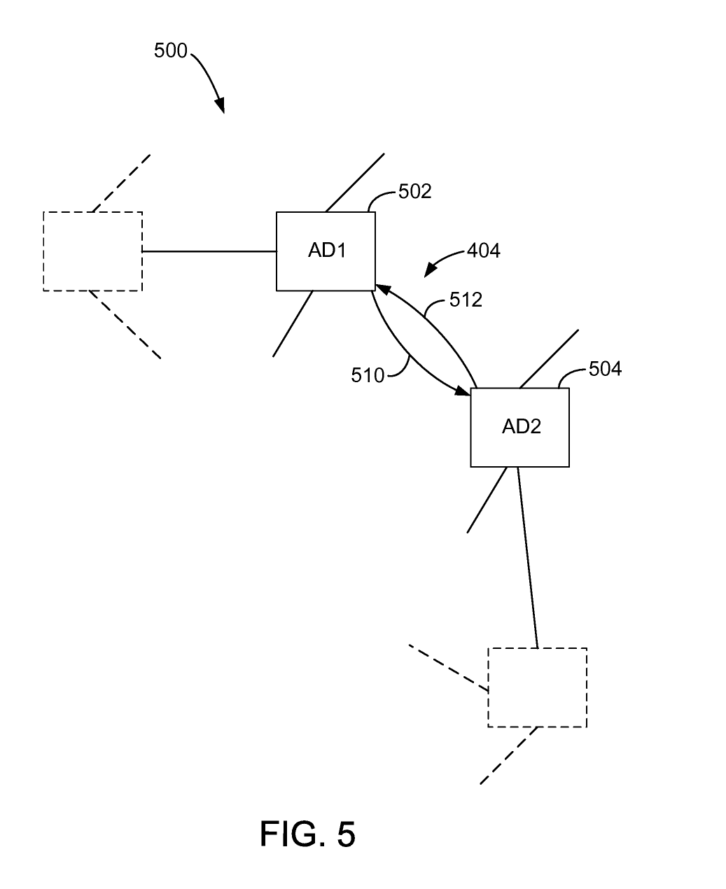

FIG. 4 is an illustration of a portion of an example ads co-occur graph 400 that may be generated in accordance with the systems and processes described herein. In the example embodiment, graph 400 is generated using occurrence results such as shown in FIG. 3 and computing devices of FIG. 2 in the advertising environment shown in FIG. 1. Graph 400 includes a plurality of nodes 402. Each node 402 may be linked to other nodes 402 by an edge 404. Each edge 404 connects to two nodes 402. In the example embodiment, each node 402 represents a single ad, or “ad group.” Each edge 404 represents a strength of relationship between the two nodes 402 that it connects. In some embodiments, graph 400 is undirected (i.e., there is only a single value that represents the strength of relationship between the two ads 402, regardless of which node is being analyzed). In other embodiments, graph 400 is a directed graph and, more specifically, a weighted directed graph (where the weights represent the strength of relationship in a specific direction), which is described in greater detail below with respect to FIG. 5.

FIG. 5 is an illustration of a portion of another example ads co-occur graph 500 that may be generated in accordance with the systems and processes described herein. In the example embodiment, graph 500 is generated using occurrence results such as shown in FIG. 3 and computing devices of FIG. 2 in the advertising environment shown in FIG. 1. Graph 500 is a “directed graph” in which each edge 404 includes two directional components: a first arc 510 and a second arc 512. First arc 510 is directed from a first node 502 (e.g., “AD1”) to a second node 504 (e.g., “AD2”). Second arc 512 is directed from second node 504 (“AD2”) to first node 502 (“AD1”). Each arc 510, 512 includes a separate value representing the strength of relationship between the two ads 502 and 504.

In reference to FIG. 4 and FIG. 5, graphs 400 and 500 are represented, in the example embodiment, as a virtual construct or data structure in the memory of a computing device such as backend system 118 (shown in FIG. 1) or computing device 200 (shown in FIG. 2). Graphs 400 and 500 are also referred to herein as “graph data structures.” Graphs 400 and 500 may be represented using any data structure capable of enabling the systems and methods as described herein. During operation, graph 500 is constructed between a plurality of ads 402. A node for each ad 402 is built, and edges 404 are constructed between nodes.

More specifically, in the example embodiment, search query logs are analyzed for a period of time, such as 30 days. A number of co-occurrences (co-occurrence events) between two ads, such as AD1 502 and AD2 504, are computed from the search query logs. This figure represents the number of times the two ads have co-occurred within search results in response to a search query submitted by a user. In some embodiments, this number may be used as the weight associated with edge 404. In other embodiments, this number is modified based on the total number of times that AD1 502 and/or AD2 504 appeared in the search query logs (whether or not they appeared together). For example, a total number of times AD1 502 appeared in the search query logs during the same 30 day period is computed, as well as a total number of times AD2 504 appeared. As such, the total number of co-occurrences may be divided by the two totals for AD1 502 and AD2 504 to yield a percentage value representing the percentage of time that both co-occurred in relation to the total time either of them occurred.

In some embodiments, graph 500 is constructed for a given time period but only for a certain ad, such as “AD1”. In other words, search query logs would be scanned to build graph 500, but only other ads co-occurring with AD1 would be built into graph 500. As such, only ads that co-occurred with AD1 would have nodes created within the graph, each other node would have only a single edge created, and that edge would be shared with AD1. In the example embodiment, graph 500 is constructed with all ads appearing within the given time period. As such, all ads appearing within the search query logs would have nodes created, each node may have many edges, each edge would be shared with another node also appearing in the search query logs, and each edge is not necessarily shared with a specific ad, such as AD1.

By way of example, presume that CMS 106 (shown in FIG. 1) is analyzing 30 days of search query log data. CMS 106 calculates the total number of co-occurrences between AD1 502 and AD2 504 as 100 times. In some embodiments, the weight of edge 404 is set to 100, representing an “absolute” strength of relationship between ads 402 (i.e., the two ads co-occurred 100 times during the 30-day time period). In other embodiments, CMS 106 calculates the total number of co-occurrences, but additionally calculates the total number of times that each ad occurs itself in the search query logs for that same 30 day period. For example, presume that AD1 502 total occurrence is 400. In other words, AD1 502 occurred 400 times during the 30-day period. Further, 100 of those times also included AD2 504 (i.e., the total number of co-occurrences). As such, the strength of relationship of AD1 502 with respect to AD2 504 can be viewed as the number of co-occurrences between AD1 and AD2 divided by the total number of occurrences of just AD1:

$$\begin{matrix}Weight ( AD 1 \to AD 2 ) = \frac{total \# co \text{-} occurrences}{Total occurrences of AD 1} \\ = \frac{100}{400} \\ = 0.25 \\ = 25 \%\end{matrix} \qquad ( 1 )$$

Weight (AD1→AD2), in some embodiments, would be assigned as the weight of arc 510, representing the relationship strength of AD2 504 in relation to AD1 502. In other words, AD2 504 appears on 25% of the search results that AD1 502 appears on.

Similarly, a strength of relationship of AD2 504 with respect to AD1 502 can be viewed as the number of co-occurrences between AD1 and AD2 divided by the total number of occurrences of just AD2 504. Presume that the AD2 504 total is 150 (i.e., AD2 occurred 150 times during the 30-day period):

$$\begin{matrix}Weight ( AD 2 \to AD 1 ) = \frac{total \# co \text{-} occurrences}{Total occurrences of AD 2} \\ = \frac{100}{150} \\ = 0.67 \\ = 67 \%\end{matrix} \qquad ( 2 )$$

Weight (AD2→AD1), in some embodiments, would be assigned as the weight of arc 512, representing the relationship strength of AD1 502 in relation to AD2 504. In other words, AD1 502 appears on 67% of the search results that AD2 504 appears on.

Using the above example, presume that an analyst identified AD1 502 as an underperforming advertisement (i.e., AD1 has some performance metric that analyst considers low). The analyst might look at graph 500 from AD1's 502 perspective and notice that AD2 504 has a significant number of co-occurrences with AD1 502 (i.e., 100 co-occurrences). The analyst may consider AD2's 504 co-occurrence “probability” with AD1 (i.e., Weight (AD1→AD2), in some sense, represents how probable is it that AD2 appears in an AD1 search query result, from a historical standpoint). However, analyst sees that AD2 504 only co-occurs 25% of the time with AD1 502, and thus the analyst may not consider AD2 504 strong enough of a relationship with AD1 502 to justify, for example, a change toward AD2's 504 settings.

On the other hand, presume that the analyst identified AD2 504 as an underperforming advertisement. The analyst might look at graph 500 from AD2's 504 perspective and notice that AD1 502 has a significant number of co-occurrences with AD2 504 (i.e., 100 co-occurrences, same as above). The analyst may consider AD1's 502 co-occurrence probability with AD2 (i.e., Weight (AD2→AD1)). Analyst sees that AD1 502 co-occurs 67% of the time with AD2 504, a number which may be high enough for analyst to consider AD1's 502 relationship strong enough with AD2 504 to justify, for example, a change of AD2's 504 settings toward AD1 502, or some aggregation of multiple strong neighbors' settings.

Further, in some embodiments, performance metrics associated with ads are considered. Performance metrics represent some measure of how well or poorly a particular ad is performing relative to some aspect of performance, such as click-through rate or conversion rate. In some embodiments, a recommendation for a settings change for an underperforming ad may only be made if a higher-performing neighbor is found. For example, presume AD1 502 is an underperforming ad, and presume that AD2 504 is a strong neighbor. If AD2 504 is also underperforming (i.e., has a low performance metric relative to AD1's performance metric), a settings change toward AD2 504 may actually be detrimental to AD1's future performance. On the other hand, if AD2 504 is performing better than AD1 502 (i.e., has a higher performance metric in some aspect), then a recommendation toward AD2's settings may be advantageous and lead to higher future performance for AD1 502. As such, in some embodiments, performance metrics for ads are collected, compared, and/or influence recommendations.

In some of the examples provided, such as with respect to FIG. 4 and FIG. 5, only two nodes are described for illustrative purposes. However, it should be understood that the systems and methods described herein may involve analysis and graphs including many nodes, and nodes with many edges or no edges.

In some embodiments, graph 500 is constructed using a MapReduce programming model. Search results logs may be large, and thus may benefit from cluster computing and parallelization. As such, search records are first converted to co-occurrence records. For example, a search record may be in a query log entry [query, ad1, ad2, ad3], wherein “query” represents some ancillary aspects of a given query, such as search terms, and where “ad1”, “ad2”, and “ad3” represent three ads that occurred within that query (and co-occurred together). The query log form is converted to a co-occurrence form [node: <nodeid>, cooccurred-ads: <list of one or more ads>], where “<nodeid>” refers to a unique ad, such as AD1 502, and where “<list of one or more ads>” refers to one or more other unique ads, such as AD2 504 that co-occurred with “<nodeid>”. As such, the example single query log entry [query, ad1, ad2, ad3] generates three separate co-occurrence entries:

TABLE 1
Example co-occurrence entries

[node: ad1, cooccurred-ads: ad2, ad3]
[node: ad2, cooccured-ads: ad3, ad1]
[node: ad3, cooccurred-ads: ad1, ad2]

In the example embodiment, after search records are converted to co-occurrence records, a “map” phase is performed. The co-occurrence records are mapped to multiple computing devices, such as computing device 200 (shown in FIG. 2), for further processing using their nodes as keys. As such, each computing device only processes a portion of the records. On each computing device, a partial graph, such as graph 500, is constructed by grouping and merging co-occurrence records for the same “<nodeid>” together. For example, consider just node “ad1”. In the above example, node “ad1” co-occurred with “ad2” and “ad3” once during the example query. Presume there was also another query [query2, ad1, ad2, ad4], which accordingly generates an “ad1” co-occurrence record (in addition to two others) of [node: ad1, cooccurred-ads: ad2, ad4]. During the “map” phase, the combination of the two “ad1” example co-occurrence records yields a node represented by [node: ad1, co-occurred-ads: ad2(2), ad3(1), ad4(1)], where the parenthetical number behind the co-occurred-ads represents a sum of co-occurrences of “ad1” with that particular ad (i.e., a total weight for the edge between “ad1” and the co-occurred-ad). As such, co-occurrence entries may be combined for each ad, and partial graphs are generated.

During a “reduce” phase, in the example embodiment, the partial graphs from the computing devices are collected and combined into a single graph using the same process as described above. As such, the full graph is constructed.

Referring now to FIG. 4 and FIG. 5, in some embodiments, the analyst may be presented with a front-end tool that allows navigation and traversing of graphs 400 and 500 such that the analyst may view a pictorial representation of graphs 400 and 500, including nodes 402, 502 and 504, edges 404, arcs 510 and 512, and their corresponding values. The front-end tool may be presented to the user using input device 212 and/or output device 214 (shown in FIG. 2). In some embodiments, analyst may be a user associated with CMS 106 (shown in FIG. 1), a user associated with content provider 102 (shown in FIG. 1), and/or a publisher 104 (shown in FIG. 1).

Further, in some embodiments, graph 500 may be used to examine aspects of ads categories. For example, the category in which an ad is classified may be examined based on the number of neighbors. In other words, the more neighbors an ad has, the bigger that category is for the ad.

It should be understood that, while some operations in the example embodiments disclosed herein may be described as being performed by an analyst (i.e., a human), these functions may alternatively be programmed to be performed by a computing device. In some embodiments, for example, the computing device may provide recommendations for advertisement settings changes for ads.

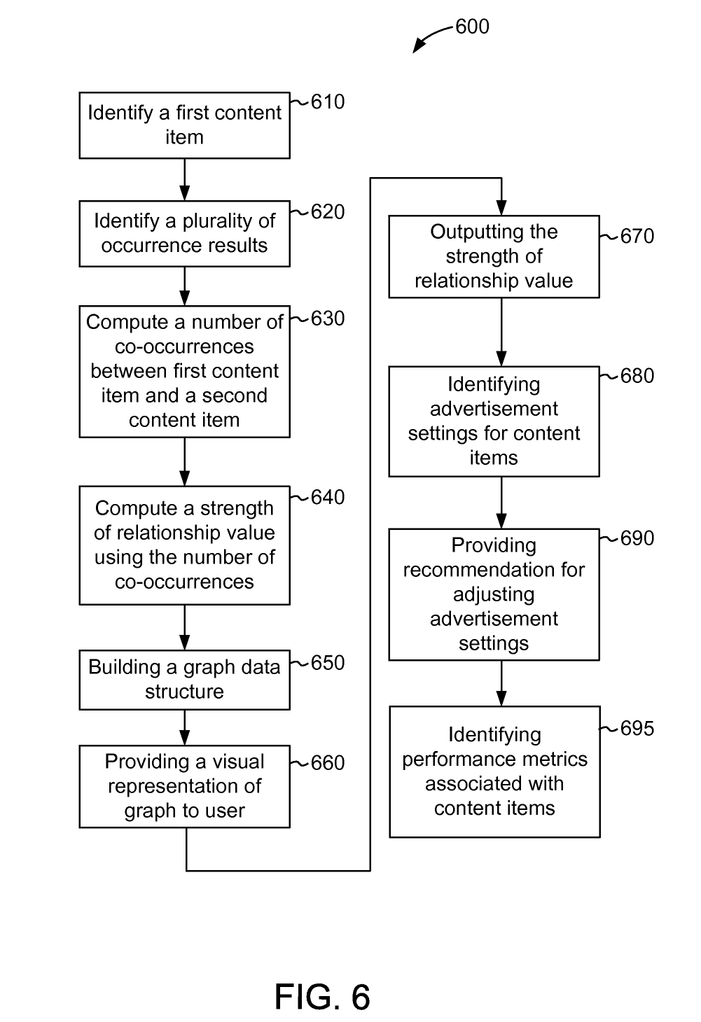

FIG. 6 is an example method 600 for identifying relationships between different online content items, such as online advertisements 310, using the computing device of FIG. 2 in the advertising environment shown in FIG. 1. Method 600 uses a computing device including a processor and a memory, such as content management systems 106 (shown in FIG. 1) and/or computing device 200 (shown in FIG. 2). In the example embodiment, method 600 includes identifying 610 a first content item in the memory, such as a first advertisement. Method 600 further includes identifying 620 a plurality of occurrence results stored in a memory. Occurrence results, in some embodiments, relates to occurrences of ads within search results. Method 600 also includes computing 630 a number of co-occurrences of the first content item and a second content item from the plurality of occurrence results. In some embodiments, a co-occurrence includes an occurrence result including both the first content item and the second content item, such as AD1 and AD2 310 (shown in FIG. 3), appearing in a single search query result 304 (shown in FIG. 3). Method 600 further includes computing 640 a strength of relationship value between the first content item and the second content item using at least the number of co-occurrences.

In some embodiments, method 600 also includes building 650 a graph data structure in the memory, such as is illustrated by graphs 400 and 500 in FIGS. 4 and 5, and as described above. In other embodiments, method 600 also includes providing 660 a visual representation of the graph data structure to a user of the computing device. In still other embodiments, method 600 also includes outputting 670 the strength of relationship value to a user of the computing device. In further embodiments, method 600 includes identifying 680 an advertisement setting for the first content item and providing 690 a recommendation for adjusting the first advertisement setting based at least in part on the relationship value between the first content item and the second content item. In another embodiment, method 600 also includes identifying 680 a second advertisement setting for the second content item, and providing 690 a recommendation based at least in part on the second advertisement setting. The advertisement settings relates to the plurality of occurrence results for the first content item. Further, in some embodiments, method 600 includes identifying 695 a first performance metric associated with the first content item and a second performance metric associated with the second content item, and providing a recommendation further is based at least in part on a comparison between the first performance metric and the second performance metric.

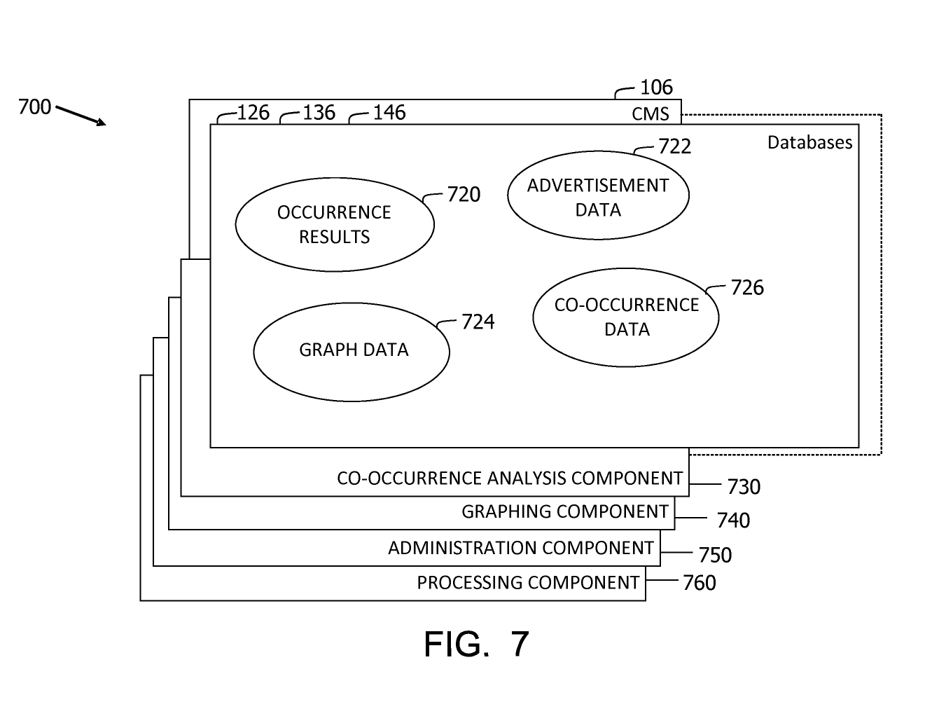

FIG. 7 is a diagram 700 of components of one or more example computing devices, for example computing device 200 (shown in FIG. 2), that may be used in the environment shown in FIG. 1. For example, one or more of computing devices 200 may form content management system 106, content provider system 102, and/or publisher system 104 (shown in FIG. 1). FIG. 7 further shows a configuration of databases 126, 136, and 146 (also shown in FIG. 1). Databases 126, 136, and 146 are coupled to several separate components within CMS 106, which perform specific tasks.

In an exemplary embodiment, databases 126, 136, and 146 are divided into a plurality of sections, including but not limited to, an occurrence results data section 720, an ads data section 722, a graph data section 724, and a co-occurrence data section 726. These sections within databases 126, 136, and 146 are interconnected to retrieve information pertaining to the operations and components described below.

CMS 106 further includes a co-occurrence analysis component 730 for examining results data 720 such as, for example, search query results 304 (shown in FIG. 3) and/or ad logs results, identifying co-occurrences between content items such as ads 310 stored in ads data 722, and storing co-occurrences data 726. CMS 106 also includes a graphing component 740 for building graphs such as graph 400 using co-occurrence data 726 and/or results data 720, and storing data associated with the graphs in graph data 724. CMS 106 additionally includes an administration component 750 for enabling users to view, traverse, and otherwise interact with the graphs. CMS 106 additionally includes a processing component 760 for performing other operations associated with identifying relationships between content items.

It will be appreciated that the above embodiments that have been described in particular detail are merely example or possible embodiments, and that there are many other combinations, additions, or alternatives that may be included.

Also, the particular naming of the components, capitalization of terms, the attributes, data structures, or any other programming or structural aspect is not mandatory or significant, and the mechanisms that implement the embodiments or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or “providing” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments of the disclosure may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the disclosure. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

While the disclosure has been described in terms of various specific embodiments, it will be recognized that the disclosure can be practiced with modification within the spirit and scope of the claims.

What is claimed is:

1. A computer-implemented method for identifying relationships between online content items, said method using a computing device including a processor and a memory, said method comprising:
identifying a first content item;
identifying a plurality of occurrence results for the first content item, wherein each occurrence result of the plurality of occurrence results includes an indicator that the first content item was retrieved along with a list of other content items based, at least in part, on an online activity of at least one user device;
computing a number of co-occurrence events involving the first content item and a second content item from the plurality of occurrence results, wherein each co-occurrence event includes an indicator that both the first content item and the second content item were retrieved together in an occurrence result; and
computing a relationship value between the first content item and the second content item using at least the number of co-occurrence events.

2. The method of claim 1 further comprising:
identifying a first advertisement setting for the first content item, wherein the first advertisement setting relates to the plurality of occurrence results for the first content item; and
providing a recommendation for adjusting the first advertisement setting based at least in part on the relationship value between the first content item and the second content item.

3. The method of claim 2 further comprising identifying a second advertisement setting for the second content item, wherein providing a recommendation further comprises providing a recommendation based at least in part on the second advertisement setting.

4. The method of claim 2 further comprising identifying a first performance metric associated with the first content item and a second performance metric associated with the second content item, wherein providing a recommendation further comprising providing a recommendation based at least in part on a comparison between the first performance metric and the second performance metric.

5. The method of claim 1, wherein identifying a plurality of occurrence results further comprises identifying the plurality of occurrence results from a plurality of search results retrieved for the at least one user device.

6. The method of claim 1, wherein identifying a plurality of occurrence results further comprises identifying the plurality of occurrence results from a plurality of search results retrieved during a first time period.

7. The method of claim 1 further comprising building a graph data structure for storage within the memory, wherein the first content item is represented by a first node, the second content item is represented by a second node, wherein a first edge connects the first node and the second node, wherein the first edge represents the co-occurrence relationship between the first content item and the second content item.

8. The method of claim 7 further comprising providing a visual representation of the graph data structure to a user of the computing device.

9. The method of claim 1 further comprising:
computing a total number of occurrences of the first content item; and
computing the relationship value by dividing the number of co-occurrence events by the total number of occurrences of the first content item.

10. A computer system comprising:
at least one processor; and
at least one memory comprising computer-executable instructions that, when executed by said at least one processor, cause said at least one processor to:
identify a first content item stored within the at least one memory;
identify a plurality of occurrence results for the first content item, wherein each occurrence result of the plurality of occurrence results includes an indicator that the first content item was retrieved along with a list of other content items based, at least in part, on an online activity of at least one user device;
compute a number of co-occurrence events involving the first content item and a second content item from the plurality of occurrence results, wherein each co-occurrence event includes an indicator that both the first content item and the second content item were retrieved together in an occurrence result; and
compute a relationship value between the first content item and the second content item using at least the number of co-occurrence events.

11. The computer system of claim 10, wherein, when executed by said at least one processor, the computer-executable instructions further cause said at least one processor to:
identify a first advertisement setting for the first content item, wherein the first advertisement setting is configured to affect occurrence results for the first content item; and
provide a recommendation for adjusting the first advertisement setting based at least in part on the relationship value between the first content item and the second content item.

12. The computer system of claim 11, wherein, when executed by said at least one processor, the computer-executable instructions further cause said at least one processor to:
identify a second advertisement setting for the second content item; and
provide the recommendation based at least in part on the second advertisement setting.

13. The computer system of claim 11, wherein, when executed by said at least one processor, the computer-executable instructions further cause said at least one processor to:
identify a first performance metric associated with the first content item and a second performance metric associated with the second content item; and
provide the recommendation based at least in part on a comparison between the first performance metric and the second performance metric.

14. The computer system of claim 10, wherein, when executed by said at least one processor, the computer-executable instructions further cause said at least one processor to identify the plurality of occurrence results from a plurality of search results retrieved for the at least one user device.

15. The computer system of claim 10, wherein, when executed by said at least one processor, the computer-executable instructions further cause said at least one processor to identify the plurality of occurrence results from a plurality of search results retrieved during a first time period.

16. The computer system of claim 10, wherein, when executed by said at least one processor, the computer-executable instructions further cause said at least one processor to build a graph data structure and store the graph data structure within the memory, wherein the first content item is represented by a first node, the second content item is represented by a second node, and a first edge connects the first node and the second node, wherein the first edge represents the co-occurrence relationship between the first content item and the second content item.

17. The computer system of claim 16, wherein, when executed by said at least one processor, the computer-executable instructions further cause said at least one processor to provide a visual representation of the graph data structure to a user of the computing device.

18. The computer system of claim 10, wherein, when executed by said at least one processor, the computer-executable instructions further cause said at least one processor to:
compute a total number of occurrences of the first content item; and
compute the relationship value by dividing the number of co-occurrence events by the total number of occurrences of the first content item.

19. Computer-readable storage media having computer-executable instructions embodied thereon, wherein, when executed by at least one processor, the computer-executable instructions cause the processor to:
identify a first content item stored within a memory;
identify a plurality of occurrence results for the first content item, wherein each occurrence result of the plurality of occurrence results includes an indicator that the first content item was retrieved along with a list of other content items based, at least in part, on an online activity of at least one user device;
compute a number of co-occurrence events involving the first content item and a second content item from the plurality of occurrence results, wherein each co-occurrence event includes an indicator that both the first content item and the second content item were retrieved together in an occurrence result; and
compute a relationship value between the first content item and the second content item using at least the number of co-occurrence events.

20. The computer program product of claim 19, further comprising instructions that when executed cause the processor to:
identify a first advertisement setting for the first content item, wherein the first advertisement setting is configured to affect occurrence results for the first content item; and
provide a recommendation for adjusting the first advertisement setting based at least in part on the relationship value between the first content item and the second content item.

21. The computer program product of claim 20, further comprising instructions that when executed cause the processor to:
identify a second advertisement setting for the second content item; and
provide the recommendation based at least in part on the second advertisement setting.

22. The computer program product of claim 20, further comprising instructions that when executed cause the processor to:
identify a first performance metric associated with the first content item and a second performance metric associated with the second content item; and
provide the recommendation based at least in part on a comparison between the first performance metric and the second performance metric.

23. The computer program product of claim 19, further comprising instructions that when executed cause the processor to identify the plurality of occurrence results from a plurality of search results retrieved for the at least one user device.

24. The computer program product of claim 19, further comprising instructions that when executed cause the processor to identify the plurality of occurrence results from a plurality of search results retrieved during a first time period.

25. The computer program product of claim 19, further comprising instructions that when executed cause the processor to build a graph data structure for storage within the memory, wherein the first content item is represented by a first node, the second content item is represented by a second node, and a first edge connects the first node and the second node, wherein the first edge represents the co-occurrence relationship between the first content item and the second content item.

26. The computer program product of claim 25, further comprising instructions that when executed cause the processor to provide a visual representation of the graph data structure to a user of the computing device.

27. The computer program product of claim 19, further comprising instructions that when executed cause the processor to:
compute a total number of occurrences of the first content item; and
compute the relationship value by dividing the number of co-occurrence events by the total number of occurrences of the first content item.
